(19) United States
(12) Patent Application Publication
(10) Pub. No.: US 2008/0208983 A1
(43) Pub. Date: Aug. 28, 2008

(54) Providing Information Regarding Mailing List Aliases

(76) Inventors: Boaz Mizrachi, Haifa (IL); Itzhack Goldberg, Hadera (IL)

Correspondence Address: LOTUS AND RATIONAL SOFTWARE;David A. Dagg, Esq., 44 Chapin Road, Newton, MA, 02459, US

(21) Appl. No.: 11/680,531

(22) Filed: Feb. 28, 2007

(51) Int. Cl. G06F 15/16

(52) U.S. Cl. 709/206

(57) ABSTRACT

Systems and methods for providing information regarding mailing list aliases to recipients of email messages that are sent using mailing list aliases are provided in the present invention. A method for providing information regarding mailing list aliases in an email message is provided. The method includes displaying an email message including at least one mailing list alias, and displaying a scope indicator in association with the mailing list alias, wherein the scope indicator provides a visual indication that a plurality of email addresses are mapped to the mailing list alias.

### FIELD OF THE INVENTION

The present invention relates to electronic mail systems in general, and in particular to providing information regarding mailing list aliases.

### BACKGROUND OF THE INVENTION

Mailing list aliases are often used in electronic mail (email) systems to allow an email message to be sent to be multiple recipients without having to individually specify the email address of each recipient. Thus, as shown by way of example in FIG. 1, an email message 100 may be sent from a computer 102 to an email server 104 and then on to a recipient computer 106 via a network 108, such as the Internet. Rather than inserting the individual email address of each intended recipient of email message 100, the recipients of email message 100 are indicated using the mailing list aliases “SPORTS-LIST” and “BUDDIES” which are mapped to one or more individual email addresses in a mapping 110. Thus, the email address “BOB@FGH.COM” is shown in mapping 110 as belonging to both the “SPORTS-LIST” and “BUDDIES” aliases, while “PHIL@SURT.ORG” belongs only to the “SPORTS-LIST” alias. When email message 100 is sent, server 104 uses mapping 110 to determine which email addresses are mapped to each mailing list alias indicated in email message 100 and sends email message 100 to the appropriate email addresses.

Although mailing list aliases are typically included within the TO and/or CC fields of email messages that are addressed to mailing list aliases, they might not be readily apparent to the recipients or might not be visible within the TO and CC fields due to the truncation of their displayed contents where their contents exceed the width of the TO and/or CC fields. Furthermore, even where recipients of such email messages do see the mailing list aliases used, they do not see their underlying email addresses. Thus, were a recipient of such an email message to respond to all of the recipients of the email message, the respondent would not know to whom the response will be sent, and thus might not appreciate the true scope of the response in terms of the number of its recipients.

### SUMMARY OF EMBODIMENTS OF THE INVENTION

The present invention in embodiments thereof discloses systems and methods for providing information regarding mailing list aliases to recipients of email messages that are sent using mailing list aliases.

In accordance with one of the aspects of the present invention a method for providing information regarding mailing list aliases in an email message is provided. The method includes displaying an email message including at least one mailing list alias, and displaying a scope indicator in association with the mailing list alias, wherein the scope indicator provides a visual indication that a plurality of email addresses are mapped to the mailing list alias.

Other aspects of the present invention provide a system for providing information regarding mailing list aliases and computer programs.

The present invention will be more fully understood from the following detailed description of the embodiments thereof, taken together with the drawings in which:

### BRIEF DESCRIPTION OF THE DRAWINGS

Embodiments of the present invention will be understood and appreciated more fully from the following detailed description taken in conjunction with the appended drawings in which:

FIG. 1 is a simplified conceptual illustration of a prior art electronic mail system employing mailing list aliases;

FIG. 2 is a simplified conceptual illustrations of an electronic mail system that provides information regarding mailing list aliases, constructed and operative in accordance with an embodiment of the present invention; and

FIGS. 3 and 4 are exemplary conceptual illustrations of email messages that may be produced by the system of FIG. 2, constructed and operative in accordance with an embodiment of the present invention.

### DETAILED DESCRIPTION OF EMBODIMENTS OF THE INVENTION

The present invention is now described within the context of one or more embodiments, although the description is intended to be illustrative of the invention as a whole, and is not to be construed as limiting the invention to the embodiments shown. It is appreciated that various modifications may occur to those skilled in the art that, while not specifically shown herein, are nevertheless within the true spirit and scope of the invention.

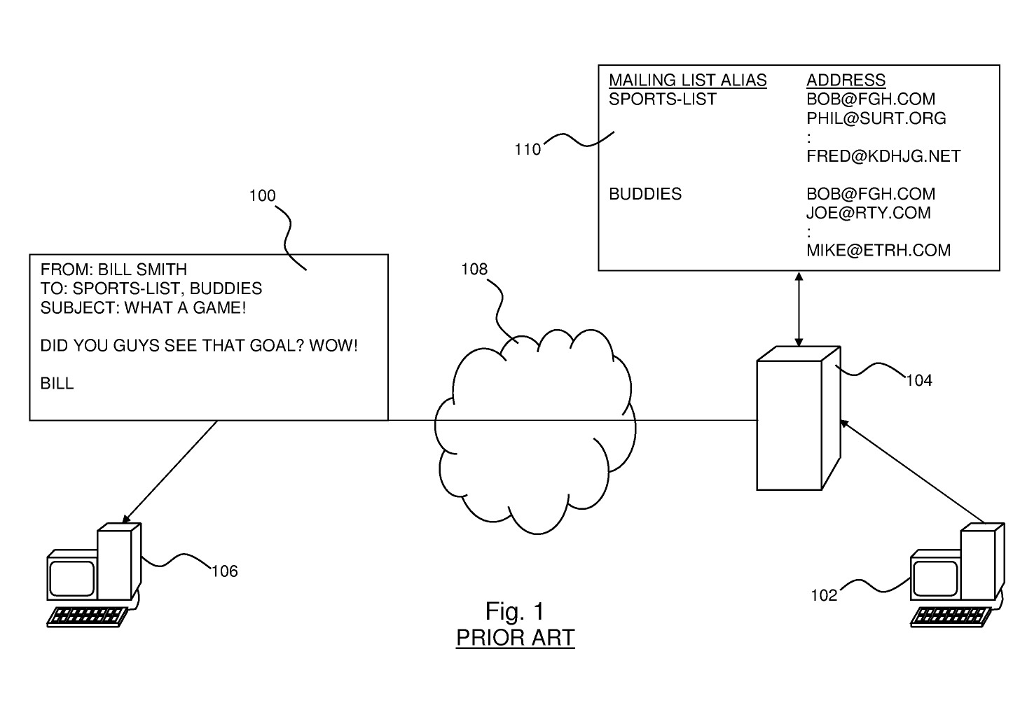

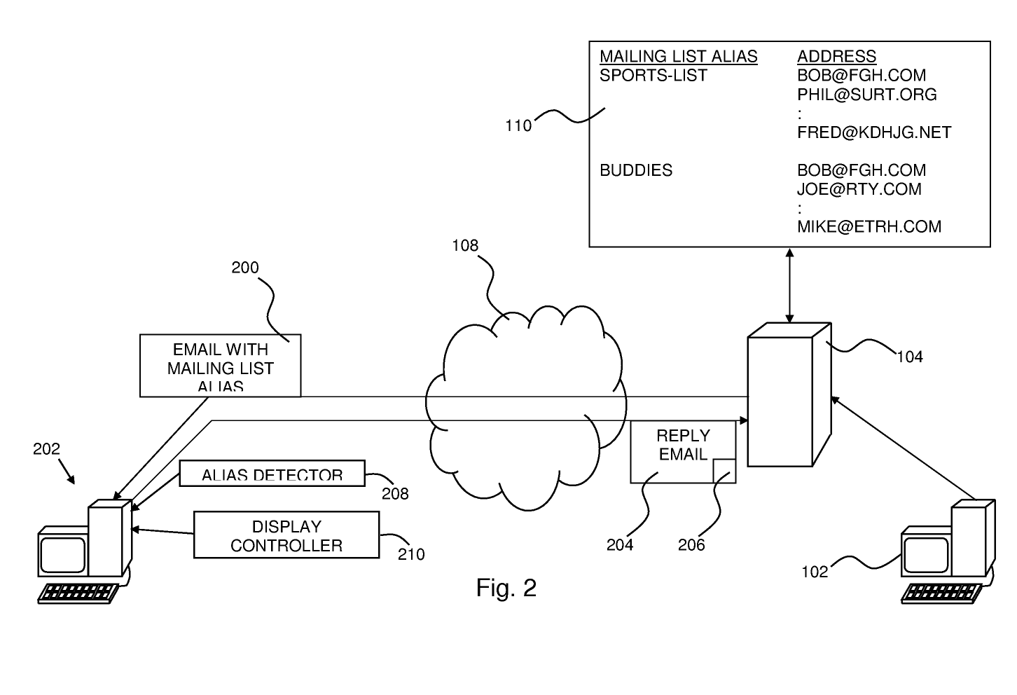

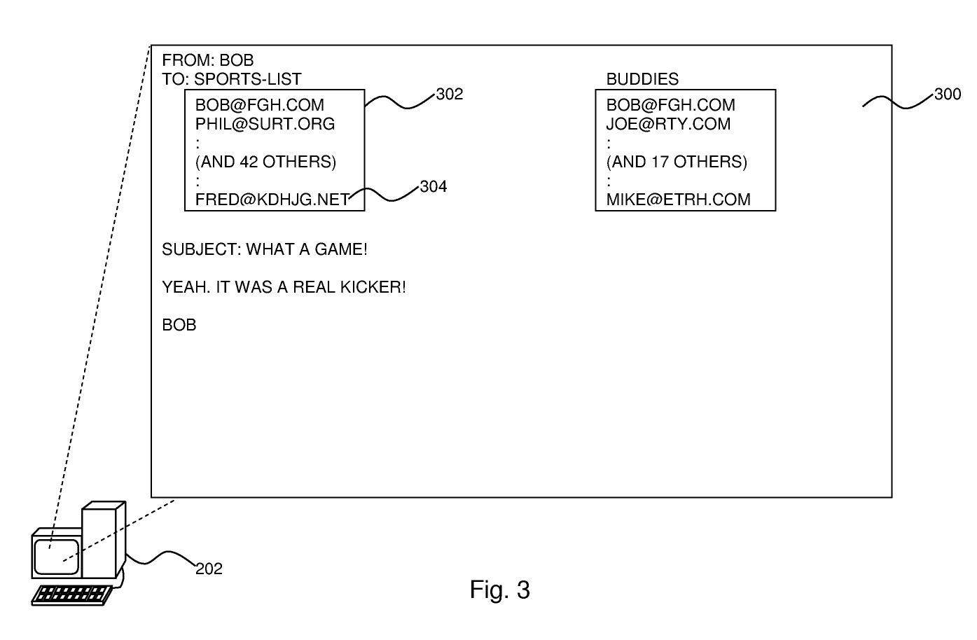

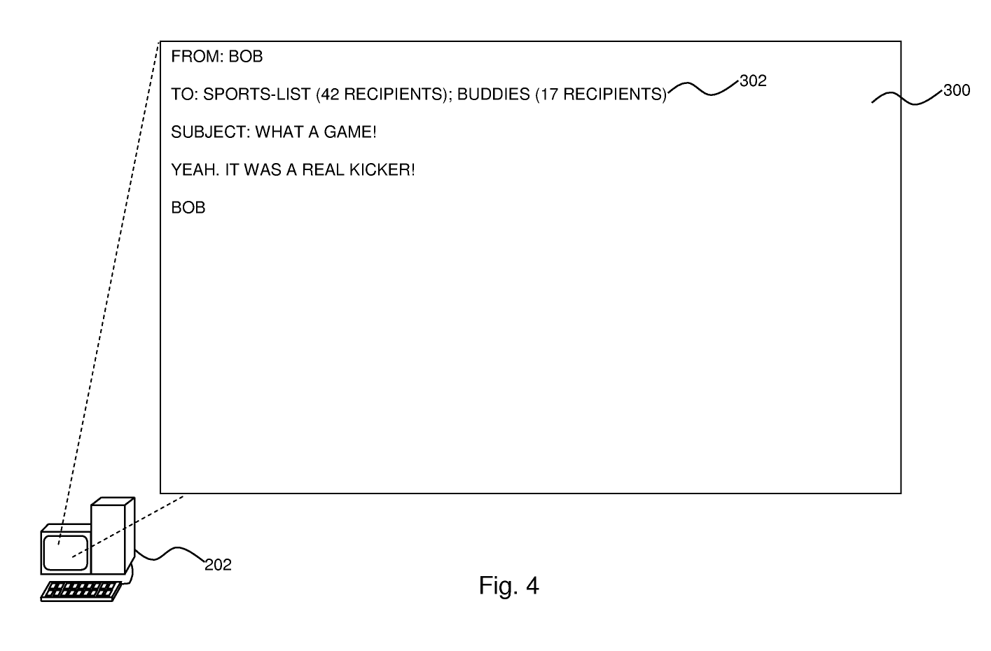

Reference is now made to FIG. 2, which is a simplified conceptual illustration of an electronic mail system that provides information regarding mailing list aliases, constructed and operative in accordance with an embodiment of the present invention, and additionally to FIGS. 3 and 4, which are exemplary conceptual illustrations of email messages that may be produced by the system of FIG. 2, constructed and operative in accordance with an embodiment of the present invention. In the system of FIG. 2, an email message 200 addressed to one or more mailing list aliases is received at a recipient computer 202, such as in the manner described in FIG. 1 with reference to computer 102, email server 104, network 108, and mapping 110. When the user of recipient computer 202 prepares a reply to email message 200, such as by pressing a “REPLY TO ALL” button that is provided by an email software application that is executed by recipient computer 202, a reply email message 204 is created and is addressed to the recipients of email message 200, including any mailing list aliases to which email message 200 is addressed. In order to indicate to the sender to whom reply email message 204 will be sent, and provide the sender with an appreciation of the true scope of reply email message 204 in terms of the number of its recipients, a scope indicator 206 is displayed in association with each mailing list alias in reply email message 204. Scope indicator 206 provides a visual indication that one or more email addresses are mapped to each mailing list alias. Exemplary implementations of scope indicator 206 are described hereinbelow with reference to FIGS. 3 and 4.

The email addresses that are associated with a mailing list alias, and/or the number of such email addresses, may be received as part of email message 200, such as within the message header, with the mailing list aliases being detected by an alias detector 208 configured with recipient computer 202. Alternatively, alias detector 208 may request and receive this information from server 104 or computer 102 (FIG. 1). A display controller 210 that is configured with computer 202 displays each scope indicator 206 in association with its mailing list alias. Alias detector 208 may request and receive this information upon detecting multiple mailing list aliases in email message 200, reply email message 204, or at the request of the recipient, such as where the recipient presses a button designated for this purpose. It is appreciated that any actions described herein that are taken by computer 202, alias detector 208, and display controller 210 may be performed by email software installed on computer 202 and configured to perform such actions.

An exemplary implementation of reply email message 204 and scope indicator 206 is shown in FIG. 3 in the form of a reply email message 300 and a scope indicator 302. In the example shown, reply email message 300 is shown addressed to the mailing list alias “SPORTS-LIST”. Scope indicator 302 is displayed as a list of one or more email addresses 304 which are mapped to “SPORTS-LIST”. Email addresses 304 may be displayed in a variety of ways, such as the abbreviated list which is shown, which may also include a number representing the number of email address 304 mapped to “SPORTS-LIST”. Email addresses 304 may alternatively be displayed as a scrolling list. Scope indicator 302 may be selected, such as by clicking on scope indicator 302 using a pointing device, and edited to modify the list of email address 304 mapped to “SPORTS-LIST” using any known mailing list editing technique. Multiple scope indicators 302 may be shown for multiple mailing lists.

Another exemplary implementation of reply email message 204 and scope indicator 206 is shown in FIG. 4 in the form of a reply email message 400 and a scope indicator 402. In the example shown, reply email message 400 is shown addressed to the mailing list alias “SPORTS-LIST”. Scope indicator 402 is displayed near “SPORTS-LIST”, such as adjoining it, as a number representing the number of email address 304 mapped to “SPORTS-LIST”.

It is appreciated that one or more of the steps of any of the methods described herein may be omitted or carried out in a different order than that shown, without departing from the true spirit and scope of the invention.

While the methods and apparatus closed herein may or may not have been described with reference to specific computer hardware or software, it is appreciated that the methods and apparatus described herein may be readily implemented in computer hardware or software using conventional techniques.

What is claimed is:

1. A method for providing information regarding mailing list aliases in an email message, the method comprising:
displaying an email message including at least one mailing list alias; and
displaying a scope indicator in association with said mailing list alias, wherein said scope indicator provides a visual indication that a plurality of email addresses are mapped to said mailing list alias.

2. The method according to claim 1 wherein said displaying said scope indicator comprises displaying a number representing the number of said email address mapped to said mailing list alias.

3. The method according to claim 1 wherein said displaying said scope indicator comprises displaying at least one of said email address mapped to said mailing list alias.

4. The method according to claim 1 wherein said displaying said scope indicator comprises displaying said scope indicator in propinquity to said mailing list alias.

5. The method according to claim 1 and further comprising:
receiving said email message including a mailing list alias; and
requesting either of a list of email addresses mapped to said mailing list alias and a number representing the number of said email address mapped to said mailing list alias.

6. The method according to claim 5 wherein said requesting comprises requesting upon detecting said mailing list alias.

7. The method according to claim 5 wherein said requesting comprises requesting upon detecting the pressing of a button designated to trigger said request.

8. A system for providing information regarding mailing list aliases, the system comprising:
an alias detector configured to detect at least one mailing list alias; and
a display controller configured to display a scope indicator in association with said mailing list alias, wherein said scope indicator provides a visual indication that a plurality of email addresses are mapped to said mailing list alias.

9. The system according to claim 8 wherein said scope indicator comprises a number representing the number of said email address mapped to said mailing list alias.

10. The system according to claim 8 wherein said scope indicator comprises at least one of said email address mapped to said mailing list alias.

11. The system according to claim 8 wherein said display controller is configured to display said scope indicator in propinquity to said mailing list alias.

12. The system according to claim 8 wherein said alias detector is configured to request either of a list of email addresses mapped to said mailing list alias and a number representing the number of said email address mapped to said mailing list alias.

13. The system according to claim 12 wherein said alias detector is configured to make said request upon detecting said mailing list alias.

14. The system according to claim 12 wherein said alias detector is configured to make said request upon detecting the pressing of a button designated to trigger said request.

15. A computer program embodied on a computer-readable storage medium, the computer program comprising:
a first code segment operative to display an email message including at least one mailing list alias; and
a second code segment operative to display a scope indicator in association with said mailing list alias, wherein said scope indicator provides a visual indication that a plurality of email addresses are mapped to said mailing list alias.

16. The computer program according to claim 15 wherein said scope indicator comprises a number representing the number of said email address mapped to said mailing list alias.

17. The computer program according to claim 15 wherein said scope indicator comprises at least one of said email address mapped to said mailing list alias.

18. The computer program according to claim 15 wherein said scope indicator is displayed in propinquity to said mailing list alias.

19. The computer program according to claim 15 wherein said second code segment is operative to request either of a list of email addresses mapped to said mailing list alias and a number representing the number of said email address mapped to said mailing list alias.

20. The computer program according to claim 19 wherein said second code segment is operative to make said request upon detecting said mailing list alias.
